(19) United States
(12) Patent Application Publication
(10) Pub. No.: US 2023/0141627 A1
(43) Pub. Date: May 11, 2023

(54) REAL-TIME ACCOUNT TAKEOVER DETECTION USING BEHAVIOR SEQUENCE CLUSTERING

(71) Applicant: PAYPAL, INC., San Jose, CA (US)

(72) Inventors: Shenjie Bao, Shanghai (CN); Yan Zhang, Shanghai (CN); Huan Li, Shanghai (CN); Yuanyuan Tang, Shanghai (CN)

(21) Appl. No.: 17/521,767

(22) Filed: Nov. 8, 2021

(51) Int. Cl. G06Q 20/40

(52) U.S. Cl. CPC G06Q 20/4016

(57) ABSTRACT

Computer security improvements relating to defenses for real-time account takeover detection using behavior sequence clustering are disclosed. A service provider may utilize a framework having computing operations for detecting and protecting from account takeovers by malicious entities that may utilize compromised accounts. In this regard, the service provider may utilize an account takeover framework and processing pipeline that may identify account behaviors executed by computing devices when using accounts with the service provider. These behaviors may be clustered into behavior sequences that may be verified as sufficiently occurring with other accounts of the service provider. If so, the behavior sequences may be identified as risky and may be used with a real-time detection system to monitor for those behavior sequences. If detected, security operations may be automatically executed to prevent further account takeover risk by malicious entities.

### TECHNICAL FIELD

The present application generally relates to improvements in computer system security, security threat detection systems in computing environments, and more particularly to identifying and clustering accounts and account behaviors executed by computing devices into behavior sequences linked to account takeovers (ATOs) for real-time prevention of further ATOs, according to various embodiments.

### BACKGROUND

As hackers and other malicious entities become more sophisticated, they may perform different computing attacks and other malicious conduct. For example, malicious actors may attempt to gain access to sensitive identification and/or authentication information, or otherwise compromise computer security credentials. Service providers may thus utilize security threat detection systems to identify suspicious behavior and malicious activities.

However, security threat detection systems may be complex, and deploying a solution in a live production computing environment may take considerable time. The longer until a new or updated solution is deployed, the more potential there is for computer security to be compromised, which damages computing systems and data privacy. Applicant recognizes there is a need for improved and faster detection of malicious or suspicious behaviors and activities by computing devices when an ATO is detected by malicious entities in order to better defend against such attacks and ATOs.

### BRIEF DESCRIPTION OF THE DRAWINGS

FIG. 1 is a block diagram of a networked system suitable for implementing the processes described herein, according to an embodiment;

FIG. 2 is an exemplary execution pipeline for providing real-time account takeover detection when an account takeover dispute is generated, according to an embodiment;

FIGS. 3A-3B are exemplary diagrams of operations for clustering account based on clusters of account behaviors executed by computing devices when using accounts that have fraudulent alerts, according to an embodiment;

FIG. 4 is a flowchart for real-time account takeover detection using behavior sequence clustering, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for real-time ATO detection using behavior sequence clustering. Systems suitable for practicing methods of the present disclosure are also provided. Note that while various examples, structures, techniques, etc. may be described with respect to a service provider in this specification, these structures, techniques, etc. are generalizable and are applicable to any entity that implements security systems and defenses for real-time ATO detection, according to various embodiments.

In an entity’s (e.g., service provider’s) systems, such as online platforms and systems that allow users to interact with, use, and request data processing, the entity may provide a computing architecture that may face different types of computing attacks coming from malicious sources over a network. These computing attacks may include ATOs, where a malicious entity (e.g. fraudster) may gain access to an account and/or otherwise compromise the account to engage in fraudulent, malicious, and/or illegitimate actions or operations with the account. The account may correspond to a digital payment account with an online transaction processor. A malicious actor may initiate a computing attack to compromise accounts in the computing environment of the service provider, such as credential stuffing, signup and/or account validation, a password attack, a web abuse (e.g., account enumeration, brute-force attacks and logins, structured query language (SQL) injection), or other type of computing attack. However, fraudsters may also compromise accounts through compromising sensitive personal, financial, and/or authentication information from users, such as through malware, phishing attacks, and the like.

To reduce risk, fraud, and loss, online transaction processors and other online service providers may implement a security and threat detection system. Conventionally it may be difficult to identify transaction-level ATOs in real-time, near real-time, and/or after a short time after the fraud occurs. For example, conventional fraud detection systems may require significant time to identify the fraud (e.g., using an extract, transform, load (ETL) process) and implement a solution, which may require manual user input and efforts. However, these ATOs may follow trends, which have certain behaviors executed by one or more malicious actors in a similar pattern or sequence. In this regard, an online transaction processor may implement one or more systems, executable pipelines, frameworks, and/or operations, as discussed herein, to cluster account behaviors that are linked to fraudulent or spoofed transactions or other ATO dispute. Spoofed transactions may correspond to those where a fraudster impersonates a user using an account during an ATO to engage in transaction processing fraudulently. This results in a transaction that is not authorized by the holder or owner of the account. Clustering may be done automatically in periodic or continual processing jobs, and therefore provide real-time and/or near real-time solutions to ATO activities and behaviors by fraudsters without requiring manual input and/or efforts to generate such solutions. This may provide rapid, automatic, and adaptive reactionary and real-time ATO detection by leveraging this account behavior clustering into behavior sequences.

In this regard, a user may wish to process a transaction, such as for a payment to another user or a transfer of currency, including fiat currency, digital currency, cryptocurrency, video game currency, and the like. A user may pay for one or more currency transactions using a digital wallet or other account with an online service provider or transaction processor (e.g., PayPal®). An account may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The account and/or digital wallet may be loaded with currency or currency may otherwise be added to the account or digital wallet. The application or website of the service provider, such as PayPal® or other online payment provider, may provide payments and the other transaction processing services via the account and/or digital wallet.

Once the account and/or digital wallet of the user is established, the user may utilize the account via one or more computing devices, such as a personal computer, tablet computer, mobile smart phone, or the like. However, the accounts may also be compromised by an ATO action by a malicious entity, fraudster, or other bad actor. In order to provide faster detection of and protection against ATOs and spoofed or fraudulent transaction processing using the accounts, such as in real-time or near real-time, the service provider may provide operations to automatically cluster account behaviors by fraudsters into behavior sequences when ATO disputes, flags, and/or alerts are raised. The service provider may initially determine accounts having a flag or alert caused by an ATO and/or disputed transaction. These accounts may be those that have a spoofed or fraudulent transaction processing alert, or other fraudulent or suspicious activity is reported or detected for those accounts. With these accounts having flags or alerts, the targeted accounts of the fraudulent or suspicious activity are determined. The targeted accounts may correspond to those that interact and/or engage with the flagged accounts having the disputes. For example, the targeted accounts may correspond to those that were targeted and/or the recipient of the spoofed or fraudulent transaction.

Once the flagged accounts having ATO disputes and the corresponding targeted accounts are determined, account behaviors by the flagged accounts leading up to the disputed activity (e.g., spoofed or fraudulent transaction) are determined. Account behaviors may correspond to those computing operations and/or activities executed by a computing device with or using the account in response to one or more user interface commands input to the computing device (e.g., by a user when using the account via a web browser or dedicated software application). In this regard, behaviors may correspond to inputs, commands, application programming interface (API) calls or requests, navigations, and the like that may be executed using a computing device when accessing and/or utilizing the account with the service provider. In some embodiments, computing logs (e.g., network traffic logs, firewall logs, Windows Event Logs (commonly referred to as a “WinEventLog”), and the like) may be used to record and/or identify these behaviors when detected and executed. Computing logs may therefore correspond to log files that record events and corresponding activities of computing devices when using accounts with the computing platform, system, and/or services of the online service provider. An exemplary log may include data such as a user agent string, source (e.g., a source IP address that may be rotated through a pool of IP addresses during a computing attack), source port, method, account number, status, uniform resource identifier (uri) path, destination, destination port, bytes out, bytes in, etc.

The behaviors may be monitored over a time period or time frame associated with the ATO dispute, such as over a time period before and/or after the disputed activity or spoofed/fraudulent transaction. Thus, account behaviors may be performed over a limited time period associated with the spoofed transactions or during a login session that causes the spoofed transactions. In some embodiments, the behaviors may include a login or authentication action, an add or remove contact identifier action, a send or receive funds with another account, an account recovery action, an add or remove transaction participant to the spoofed transaction or another transaction, and the like. Further, the account behaviors may include measurements of a user action, a requested and/or authorized security verification by computing devices with a server system, a time of the authorized security verification, a login from a website, a login from a mobile application flow, a transaction processing action, or a transaction processing sequence between computing devices. The account behaviors may also include IP addresses and IP address information, such as an autonomous system number (ASN) for an autonomous system (AS) providing the IP address used by the computing device and/or for the account behavior. Further, the account behaviors may include endpoint information for the targeted accounts and/or payload data for payloads uploaded and/or sent using the account, including those payloads sent to the targeted account.

When providing real-time or near real-time ATO detection for fraud prevention, a processing job of an ATO detection application and/or operations may be executed periodically to cluster account behaviors into sequences of account behaviors that are associated with the ATO and/or fraudulent activity engaged in during the ATO (e.g., based on an ATO disputed activity, such as a spoofed transaction). The processing job may be executed at certain times and/or after certain time periods, such as hourly, daily, weekly, monthly, or the like. The processing job may review the account behaviors by the account over the time period for the processing job, where the account behaviors were monitored and/or extracted from data logs for that time period. The time period may be a prior period to the ATO dispute but may also examine account behaviors after the ATO dispute. For example, the processing job may identify and/or determine account behaviors for a twelve-hour period prior to the ATO dispute, as well as another twelve hours after the ATO dispute if desired; however, other time periods may be used.

The processing job for the ATO detection may cluster those behaviors into sequences, which may link either sequentially or in another order, those account behaviors leading up to the ATO dispute, such as the spoofed or fraudulent transaction. For example, during an ATO, a fraudster may login to an account, add a phone number for the account and/or the fraudulent recipient party of a fraudulent transaction, and then login again later to finish the fraudulent transaction. This may lead to a pattern or sequence of behaviors (e.g., A - initial login, B - add phone number(s), and C - further login for transaction completion, or ABC where one phone number is added and ABBC where two phone numbers are added for sender/recipient parties). The account behaviors may be directly sequential by the computing device when executing those behaviors via a user interface and with a server using the account. For example, a sequence or pattern may require those account behaviors to have been executed on order and sequentially. However, the account behaviors may also have interceding behaviors between different behaviors, which may not be linked to the ATO dispute, such as only those account behaviors linked to the ATO dispute are reviewed and linked for clustering into the behavior sequences or patterns. Further, different behaviors may be associated with identifiers, which may allow for faster and/or more efficient clustering by reducing data required for sequence or pattern identification.

Once clustered into behavior sequences, the ATO detection operations executing the processing job may identify one or more of these sequences as risky. In order to do this, the operations may determine that one or more behavior sequences meet or exceed a threshold number or amount of account behaviors to indicate that the behavior sequence may correspond to the ATO dispute. For example, with only one or two behaviors identified and clustered for an ATO dispute, the relatively low number of behaviors may not be sufficient to link those behaviors to an ATO dispute (e.g., a login alone, or a login with an add transaction participant sequence, may not indicate fraud those behaviors may be widely common over the entire set of accounts having ATO disputes). However, with a number of behaviors in the sequence above a threshold, the service provider may determine that there is a link or nexus between that sequence of activities and the corresponding ATO dispute. With such sequences that meet or exceed the threshold number, the ATO detection operations may then determine if the identified pattern occurs at or over a sufficient rate or threshold with the overall population of accounts having ATO disputes. This may verify that the sequence occurs with a sufficient percentage of those accounts in order to associated that sequence of behaviors with the corresponding ATO disputes. The threshold number may be set by an administrator, data scientist, or other user configuring the ATO detection system, or may be set by the system, such as learned based on past behavior sequences of certain lengths that correspond to ATO disputes.

Thus, the behavior sequence is used to cluster the accounts having that behavior sequence into a cluster that is verified on the overall population. This allows a determination of whether the clustered accounts meet or exceed a threshold number or percentage over the overall population. If this occurs, the behavior sequence is then identified and confirmed as risky for at least the time period until the next processing job further clusters account behaviors into behavior sequences that is verified as risky over the population of accounts. Further, one or more actions or security operations may be executed with the clustered accounts meeting or exceeding the threshold number or percentage. For example, those clustered accounts from the population of accounts based on the risky behavior sequence may be prevented from executing additional computing operations or require additional security measures before processing transactions. This may also occur if the risky behavior sequence is further detected with those clustered accounts at a present or future time even if the risky behavior sequence has been removed from monitoring of the accounts. The clustered accounts may also each be, individual or within the cluster, monitored for additional behavioral sequences that may be identified as shared between those accounts and potentially risky.

The risky behavior sequence is then used by the ATO detection operations to monitor account behaviors of additional accounts moving forward in time and/or that are currently executing, or recently executed in the past. The ATO detection operations may determine if the behavior sequence reoccurs by one or more accounts, which may flag those accounts as potentially engaging in fraudulent behavior and/or where a malicious entity has performed an ATO and may engage in the fraudulent behavior. When a new processing job to cluster account behaviors into behavior sequences is executed, the previously identified risky sequence(s) may be removed as a risky sequence or may be retained by the ATO detection operations. Retention of the previously identified behavior sequences may expire after a certain amount of time and/or after a certain number of further processing jobs.

When an account is flagged and/or identified as executing the behaviors in the behavior sequences, the corresponding online transaction processor or other service provider may execute one or more solutions, security operations, and/or activity prevention operations. For example, the service provider may prevent activities that a computing device may attempt to execute via the account, such as a fraudulent activity or spoofed/fraudulent transactions. The security and/or prevention operations may therefore prevent one or more additional operations that may be requested or attempted to be executed by a computing device using the account via the service provider’s online platforms and computing services.

Additionally, further operations may be executed to determine that a human and/or valid user is using the corresponding computing device with the account. This may include issuing a manual challenge, such as CAPTCHA challenges, an activity or a question requiring human knowledge and/or skills, and other challenges to identify automated attacks and/or operations by malicious entities with a compromised account during an ATO. Further, multifactor authentication may be used to identify that the user is a valid user, such as by sending a time-limited code to another device or account (e.g., email account) that is required to be entered to perform the operations. The account may also be requested to enter data specific to an account challenge that may only be known by the valid user.

In this manner, faster ATO detection and prevention may be provided to compromised accounts by executing periodic processing jobs with account behaviors. These behaviors may correspond to executed processing operations, user interface inputs, data transmissions, and/or API calls and requests between a computing device using a digital account with a service provider’s computing systems, platforms, and applications. The account behaviors may be automatically clustered and verified on the population of compromised accounts and/or those having ATO disputes without requiring user configuration of the clusters, thereby providing faster and more coordinated verification of risky account behavior sequences and patterns. Once a risky behavior sequence is identified, solutions to prevent further ATOs and fraudulent or malicious activity may be automatically implemented without requiring manual configuration and deployment, which may take considerable time and efforts.

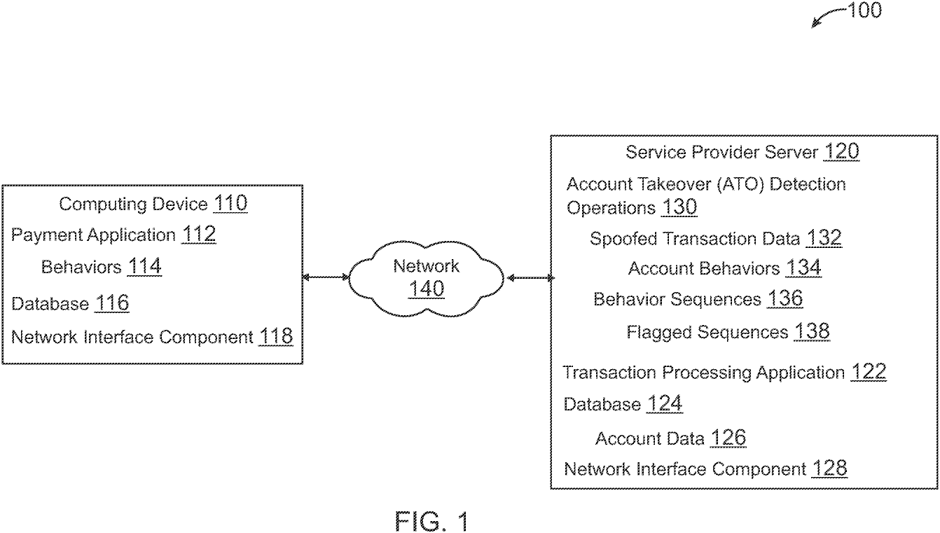

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a computing device 110 and a service provider server 120 in communication over a network 140. Computing device 110 may be utilized by a valid user of an account, or instead may be used by a malicious user or other bad actor to perform an ATO of the valid user’s account over network 140. Service provider server 120 may provide various data, operations, and other functions over network 140 in order to identify if computing device 110 may also be compromised, and therefore be performing an ATO of the valid user’s account. In this regard, service provider server 120 may cluster account behaviors of compromised accounts having ATO disputes in order to identify risky behavior sequences. Service provider server 120 may then implement one or more solutions and/or security measures or operations to prevent further ATOs when these risky behavior sequences are detected.

Computing device 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Computing device 110 may be implemented as a communication device that may utilize appropriate hardware and software configured for wired and/or wireless communication with service provider server 120. For example, in one embodiment, computing device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Computing device 110 of FIG. 1 contains a payment application 112, a database 116, and a network interface component 118. Payment application 112 may correspond to executable processes, procedures, and/or applications with associated hardware. In other embodiments, computing device 110 may include additional or different modules having specialized hardware and/or software as required.

Payment application 112 may correspond to one or more processes to execute software modules and associated components of computing device 110 to provide features, services, and other operations for a user over network 140, which may include accessing and/or interacting with service provider server 120, for example, to process a transaction, payment, or transfer. In this regard, payment application 112 may correspond to specialized software utilized by a user of computing device 110 that may be used to access a website or UI provided by service provider server 120 to perform actions or operations. In various embodiments, payment application 112 may correspond to a general browser application configured to retrieve, present, and communicate information over the Internet (e.g., utilize resources on the World Wide Web) or a private network. For example, payment application 112 may provide a web browser, which may send and receive information over network 140, including retrieving website information (e.g., a website for a merchant), presenting the website information to the user, and/or communicating information to the website including navigating between webpages to login to accounts, process transactions, and/or otherwise utilize computing services.

However, in other embodiments, payment application 112 may include a dedicated software application of service provider server 120 or other entity (e.g., a merchant) resident on computing device 110 (e.g., a mobile application on a mobile device), which may be configured to view and utilize data via user interfaces (e.g., applications interfaces displayable by a graphical user interface (GUI) associated with payment application 112) and request execution of computing operations when utilizing accounts with service provider server 120. Thus, payment application 112 may provide one or more of user interfaces, for example, via graphical user interfaces (GUIs) presented using an output display device of computing device 110, to enable the user associated with computing device 110 to utilize computing services, platforms, and applications of service provider server with accounts, which may request execution of computing operations through user interface commands and other user inputs.

Payment application 112 may provide transaction processing, such as through a user interface enabling the user to enter and/or view a transaction for processing. This may be based on a transaction generated by payment application 112 using a service provider platform or website, merchant marketplace, or by performing peer-to-peer transfers and payments via service provider server 120 in conjunction with another account and/or computing device. Payment application 112 may access accounts and view and/or utilize account information, user financial information, and/or transaction histories. In some embodiments, different services may be provided by service provider server 120 via payment application 112 including social networking, messaging, media posting or sharing, microblogging, data browsing and searching, online shopping, and other services available through service provider server 120. Thus, payment application 112 may also correspond to different service applications and the like that are associated with service provider server 120.

When using payment application 112, a bad actor may execute an ATO using compromised credentials, a computing attack, and/or automated script to compromise and account provided by service provider server 120 and/or conduct fraud via the account. For example, executable scripts may be used for account enumeration, multiple login attempts, scripted form filling, and the like. Other types computing attacks may correspond to a fraudulent transaction processing request, a password or eavesdropping attack, a session hijacking or Man-in-the-Middle (MitM) attack, or other type of computing attack that compromises credentials, or the bad actor may utilize one or more known compromised account credentials, financial information, and/or personal information (e.g., through black market compromised data lists). However, where computing device is not used by a bad actor, a valid user may also use payment application 112 validly and engage in transaction processing.

When using payment application 112 with service provider server 120 to access and utilize an account provided by service provider server 120 (either validly or fraudulently during an ATO), computing operations and activities may be requested and/or executed. These may correspond to behaviors 114, which may include computing operations and/or activities executed by computing device 110 via a user interface of payment application 112 to execute user commands based on user requests, inputs, and the like. These computing operations may request data processing with or using the requested account in response to one or more inputs, commands, API calls or requests, navigations, and the like. Behaviors 114 may be received and/or logged by service provider server 120. Thus, during behaviors 114 with service provider server 120, a corresponding computing log may include data that records and/or identifies behaviors 114 that are performed by computing device 110 when using a corresponding account with service provider server 120.

Computing device 110 may further include database 116 stored on a transitory and/or non-transitory memory of computing device 110, which may store various applications and data and be utilized during execution of various modules of computing device 110. Database 116 may include, for example, identifiers such as operating system registry entries, cookies associated with payment application 112 and/or other applications, identifiers associated with hardware of computing device 110, or other appropriate identifiers, such as identifiers used for payment/user/device authentication or identification, which may be communicated as identifying the user/computing device 110 to service provider server 120. Moreover, database 116 may store operations and data associated with behaviors 114 and/or used when recording behaviors 114 by service provider server 120 including identifiers for computing device 110, computer event logs, network traffic data, and the like that may be provided to service provider server 120.

Computing device 110 includes at least one network interface component 118 adapted to communicate with service provider server 120 and/or another device or server over network 140 for electronic transaction processing and other computing services. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider server 120 may be maintained, for example, by an online service provider, which may provide ATO detection and protection systems for computing systems and infrastructure of service provider server 120. In this regard, service provider server 120 includes one or more processing applications which may be configured to interact with computing device 110 to determine whether computing device 110 is performing an ATO and/or whether previous account behavior detected as being performed by computing device 110 indicates an ATO. In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes ATO detection operations 130, a transaction processing application 122, a database 124, and a network interface component 128. Transaction processing application 122 and ATO detection operations 130 may correspond to executable processes, procedures, and/or applications with associated hardware. In other embodiments, service provider server 120 may include additional or different modules having specialized hardware and/or software as required.

ATO detection operations 130 may correspond to one or more processes to execute modules and associated specialized hardware of service provider server 120 to provide operations, an application, and/or a framework to detect and protect against computing attacks and fraudulent activity caused by ATOs of accounts provided by service provider server 120. In this regard, ATO detection operations 130 may correspond to specialized hardware and/or software used by service provider server 120 to monitor account behaviors, including behaviors 114 from computing device 110, and cluster these account behaviors into patterns or sequences. Further, ATO detection operations 130 may verify that the sequences sufficiently occur in a population of compromised accounts and/or those having ATO disputes in order to automatically execute solutions and security operations to prevent further ATOs.

In this regard, ATO detection operations 130 may include different operations for detection and protection from computing attacks and ATOs based on spoofed transaction data 132 for a set of accounts having ATO disputes, flags, or alerts, such as those flags and/or alerts that may be generated when fraudulent activity and/or spoofed/fraudulent transactions are detected. Spoofed transaction data 132 may be determined for those accounts having an ATO dispute or other flag or alert that indicates the account was used fraudulently by a malicious user. Thus, the set of accounts may correspond to a subset of all accounts and/or a specific demographic or type of accounts (e.g., US accounts, merchant accounts, etc.) provided by service provider server 120 so that the subset identifies a population of accounts having an ATO indication or other fraud alert.

Using spoofed transaction data 132, ATO detection operations 130 may determine account behaviors 134. As previously discussed, account behaviors 134 may correspond to computing operations and/or activities executed by computing device when utilizing computing services of service provider server 120. The computing operations may be executed responsive to one or more user interface commands, inputs, requests, and the like, and may include executable commands, API calls or requests, data retrieval and/or processing, navigations between resources, and other executable tasks perform by a computing device when using an account with the computing operations, applications, and platforms of service provider server 120 for a corresponding service. Account behaviors 134 may include behaviors 114 where computing device 110 may previously have used an account with an ATO dispute. However, in other embodiments, behaviors 114 may also later be monitored where computing device 110 may be currently using an account and risky behavior sequences are already identified. Account behaviors 134 may be monitored over a period of time and logged with accounts and/or in one or more databases including big data repositories. Account behaviors 134 may be logged with corresponding account identifiers, which may be hashed or tokenized for data privacy, in order to allow for later retrieval. Further, ATO detection operations 130 may also use a network traffic, system event, and/or other computing log generated from interactions by computing devices with service provider server 120 when using logs to determine account behaviors including machine data and identifiers, IP addresses, payloads, endpoints, API calls and requests, and/or other data relevant to a behavior.

Using account behaviors 134, behavior sequences 136 may be generated by ATO detection operations using one or more processing jobs that may be executed periodically. This may be done using a clustering operation to identify one or more account behaviors in a time period that lead up to the ATO dispute, such as the disputed transaction identified as spoofed or fraudulent, and/or in a time period after the ATO dispute. The clustering operation may identify and cluster any of account behaviors associated with the ATO dispute or may require a minimum number or length of the behaviors to cluster into a behavior sequence or pattern. For example, the clustering operation may require a minimum of three or four account behaviors to be clustered as occurring in the time period associated with the ATO dispute. This may eliminate clustering account behaviors into sequences that are deemed too small or short to provide significance or meaningful insight into those behaviors being executed by fraudsters and other bad actors with the ATO dispute. Once behavior sequences 136 are determined and identified as potentially risky, behavior sequences 136 are verified as risky on the overall population of accounts and/or the set of account having the ATO disputes during the processing job(s). Verification may include clustering, determining, and/or identifying the accounts having one of behavior sequences 136 being performed with or occurring by those accounts, such as in the time period associated with an ATO dispute. If the clustered/identified accounts having one of behavior sequences 136 meets or exceeds a threshold number or percentage of all accounts, then the corresponding one of behavior sequences 136 may be identified as risky and added as one of flagged sequences 138.

Flagged sequences 138 may then be used for account behavior monitoring and ATO and/or fraud prevention. For example, ATO detection operations 130 may include one or more operations to protect from ATO computing attacks and fraudulent activity. ATO detection operations 130 may include manual challenges, such as CAPTCHA and other requests that may require a user to identify as a human user and/or provide some information so that that user can be verified. This may also include multifactor authentication challenges. These challenges may be issued in response to detecting flagged sequences 138 by a computing device during use of an account, such as when performing logins, executing computing operations via the account, engaging in electronic transaction processing, and the like. In further embodiments, flagged sequences 138 may be used to bar, prevent, or reverse further activities engaged in by a computing device using a corresponding account, such as a transaction processed using the account. Thus, ATO detection operations 130 may interface with, monitor, and/or exchange data with transaction processing application 122 for executing processing jobs to cluster account behaviors into sequences and using those sequences for monitoring additional accounts.

Transaction processing application 122 may correspond to one or more processes to execute modules and associated specialized hardware of service provider server 120 to provide a service to end users of service provider server 120, such as to process a transaction between users or entities or provide other computing services. In this regard, transaction processing application 122 may correspond to specialized hardware and/or software used by a user associated with computing device 110 to perform one or more services, which may be protected from computing attacks, fraudsters, and the like using ATO detection operations 130 during ATOs of accounts provided by service provider server 120. In some embodiments, transaction processing application 122 may be used to establish an account and/or digital wallet, which may be used to generate and provide user data for the user, as well as process transactions. In various embodiments, financial information may be stored to the account, such as account/card numbers and information. A digital token for the account/wallet may be used to send and process payments, for example, through an interface provided by service provider server 120. The payment account may be accessed and/or used through a browser application and/or dedicated payment application executed by computing device 110 to engage in transaction processing through transaction processing application 122. Transaction processing application 122 may also correspond to messaging, social networking, media posting or sharing, microblogging, data browsing and searching, online shopping, and other services available through service provider server 120. Transaction processing application 122 may be used to determine account behaviors 134, behavior sequences 136, and flagged sequences 138 based on spoofed transaction data 132.

Additionally, service provider server 120 includes database 124 used to store information, which may be used with computing device 110 and/or the operations of transaction processing application 122 and ATO detection operations 130. Database 124 may store various identifiers associated with computing device 110. Database 124 may also store account data, including payment instruments and authentication credentials, as well as transaction processing histories and data for processed transactions. Database 124 may store account data, financial information, or other data generated and stored by transaction processing application 122 including data associated with ATOs, such as spoofed transaction data 132, account behaviors 134, behavior sequences 136, and/or flagged sequences 138. Such data may include account data 126 and/or data determined by ATO detection operations 130 when identifying ATO behavior sequences for implementing security operations.

In various embodiments, service provider server 120 includes at least one network interface component 128 adapted to communicate computing device 110 and/or other devices, servers, or resources over network 140 for electronic transaction processing and other computing services. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

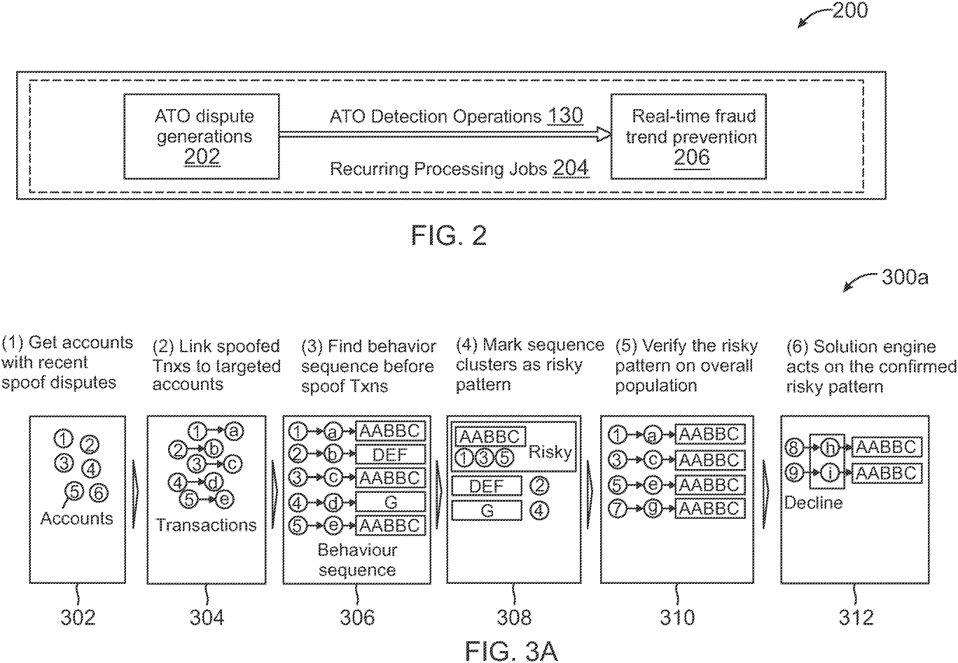

FIG. 2 is an exemplary execution pipeline 200 for providing real-time account takeover detection when an account takeover dispute is generated, according to an embodiment. Execution pipeline 200 includes operations which may be executed using ATO detection operations 130 of service provider server 120, discussed in reference to system 100 of FIG. 1. In this regard, execution pipeline 200 includes an exemplary execution pipeline for processing jobs that may be used to provide real-time ATO detection and prevention for computing systems, platforms, and applications of service provider server 120.

In execution pipeline 200, initially, ATO dispute generations 202 occur where an ATO dispute may be provided by a user in response to detection of an ATO, a potential ATO (e.g., a detection of a foreign or unknown device, IP address, location, or the like attempting to access an account), and/or a fraudulent activity including spoofed transactions. In further embodiments, some or all of ATO dispute generations 202 may be generated automatically in response to risk analysis and detection, fraud detections, or the like. For example, an intelligent risk and fraud detection system may identify ATOs and/or spoofed transactions, which may be used to automatically flag accounts as having an ATO.

ATO dispute generations 202 may then be provided to ATO detection operations 130 for determination, extraction, and/or identification of account behaviors. As discussed herein, account behaviors may correspond to those computing operations executable by computing devices with a service provider’s computing services, applications, and platforms. The computing operations may be performed in response to one or more user commands, such as user interface commands that may be input through a keyboard, mouse, touch screen, keypad, voice, image or video, or other input type, but may also be automated commands performed by scripted computing operations including malicious automated bots. ATO detection operations 130 may then execute, periodically at specific times and/or time intervals, recurring processing jobs 204.

Recurring processing jobs 204 then seek to cluster account behaviors into account behavior sequences. These sequences may be identified as potentially risky if one or more of those sequences meet or exceed a threshold number of behaviors, and further those behavior sequences are verified as occurring at or over a threshold percentage or number over a selected population of accounts. When this occurs, the behavior sequence is identified and flagged as risky. Risky behavior sequences are then used by ATO detection operations 130 in order to provide real-time fraud trend prevention 206. Real-time fraud trend prevention 206 may monitor for further occurrences of the risky behavior sequence and take one or more actions using a solution engine to prevent further ATOs and/or fraudulent activities. For example, the solution engine may include one or more rules to prevent further actions or activities using an account when the risky behavior sequence is detected, provide manual challenges, or perform other security operations to prevent further abuse from ATOs.

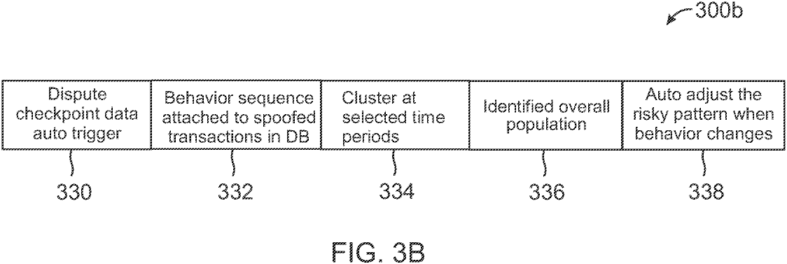

FIGS. 3A-3B are exemplary diagrams 300a and 300b of operations for clustering account based on clusters of account behaviors executed by computing devices when using accounts that have fraudulent alerts, according to an embodiment. Diagrams 300a and 300b of FIGS. 3A and 3B include operations for detection and protection of ATOs from clustered account behaviors identified as risky, which may be executed using ATO detection operations 130 of service provider server 120, discussed in reference to system 100 of FIG. 1.

With regard to diagrams 300a and 300b, execution pipeline 200 from FIG. 2 is shown in further detail. In diagram 300a of FIG. 3A, exemplary accounts, spoofed transactions, and corresponding clustered sequences or patterns of account behaviors are shown. In diagram 300b of FIG. 3B, operations that are executed in a live production computing environment for ATO detection and protection, such as by ATO detection operations 130, are shown. In this regard, ATO identifications 302 and targeted account identifications 304 are executed in response to an auto trigger 330 for ATO dispute checkpoint data. For example, auto trigger 330 may be triggered and executed in response to starting of processing job to cluster account behaviors or expiration of a previous time period associated with a previous processing job that clustered account behaviors. Thus, auto trigger 330 may be based on ATO disputes and may utilize corresponding account data for those accounts linked to the ATO disputes.

During ATO identifications 302, accounts having recent spoofed transaction disputes are identified and corresponding account data for those accounts is accessed and/or retrieved. These accounts may correspond to those having flags or alerts that indicate an ATO occurred and/or fraudulent or malicious activities were performed by an unauthorized party with the account, such as a spoofed transaction. Thereafter, the targeted accounts linked to the spoofed transactions or other ATO activity by the identified accounts are identified during targeted account identifications 304. Identification of the targeted accounts during targeted account identifications 304 may assist ATO detection operations with identifying account behaviors associated with the corresponding spoofed transactions and/or other ATO activity. Thus, targeted account identifications 304 may assist in properly clustering account behaviors into behavior sequences or patterns that indicate risky behavior potentially associated with an ATO.

With ATO identifications 302 and targeted account identifications 304, behaviors between these accounts over a time period are identified, extracted from computing logs, and/or determined from monitored and stored data. As discussed herein, account behaviors may correspond to computing operations executable with an online service provider’s computing services, platforms, and/or applications via user interface commands when using an account with the service provider. Computing operations may include inputs, commands, API calls or requests, navigations, database queries and/or changes, uploads, downloads, and the like that may be executed using a computing device. Data for the account behaviors may come from computing logs that log and record events and activities by computing devices.

During behavior clustering 306, operations may be performed to provide a behavior sequence attachment 332 of identified behavior sequences to spoofed transactions in a database. For example, behavior clustering 306 may seek to identify one or more behaviors as being linked to the accounts having the ATO dispute and/or the accounts targeted during the spoofed transaction and/or ATO activity. In some embodiments, any behavior may be identified for a potential sequence, and therefore may be 1 to N number of account behaviors. However, a threshold number of account behaviors may also be required, as discussed further below. In this regard, during behavior clustering 306, compromised account “2” is shown having a behavior sequence with targeted account “b” of “DEF” and compromised account “4” is shown having a behavior sequence with targeted account “d” of “G”. However, each of compromised accounts “1”, “3”, and “5” are shown as having a behavior sequence with targeted accounts “a”, “c”, and “e” of “AABBC”. Once the behavior sequences are identified by behavior clustering 306, behavior sequence attachment 332 may attach those sequences to the spoofed transaction or other ATO activity in a database, such as by linked to the activity and/or compromised/targeted accounts.

During the processing job, sequence marking 308 is performed during clustering time periods 334 in order to mark behavior sequences as potentially risky. Marking the behavior sequences as risky may be done based on the account sequences as meeting or exceeding the threshold number of required account behaviors to be deemed as meaningful and/or indicative of fraud. ATO detection operations 130 may require that the behavior sequences exceed a threshold number, which may be four account behaviors. Thus, during clustering time periods 334, sequence marking 308 may ignore the clustered sequences attached to accounts 2 and 4. In diagram 300a, only the sequence AABBC may be identified as potentially risky.

During a sequence verification 310, an identified overall population 336 of accounts is examined to determine whether the potentially risky sequence of account behaviors occurs frequently enough (e.g., at or over a threshold percentage or number) to be identified as a behavior sequence that needs monitoring and enforcement to protect from ATOs. In this regard, a threshold percentage or number of accounts within identified overall population may be required to be detected as performing the behavior sequence of AABBC, which may be further required to be linked to a spoofed transaction and/or ATO activity. Thus, in some embodiments even those behavior sequences meeting or exceeding the minimum threshold number of sequences may be ignored if those sequences do not adequately occur over the population of accounts to identify as significant and/or indicative of malicious or fraudulent behavior during an ATO. This may be done by clustering those accounts having AABBC linked to a spoofed transaction or other ATO dispute. The account cluster may then be compared to the overall population to determine if the threshold is met or exceeded. Additionally, actions may be taken with the account cluster, such as alerting account holders of the behaviors and sequences, prevention from further activity (including if that sequence is detected again), and/or other security operations.

Thereafter, using a solution engine 312, ATO detection operations 130 may implement one or more protective, preventative, and/or security operations on accounts when the behavior sequence of AABBC verified as risky is detected by an account of service provider server 120. For example, ATO detection operations 130 may prevent further activities by that account, including electronic transaction processing. A corresponding computing device may be prevented and/or removed access (e.g., logged out and refused further access) to the account and/or a connection with the computing device may be terminated. Further, a manual challenge and/or multifactor authentication may be issued. An auto-adjustment 338 may further be used to adjust the risky pattern when behaviors change. For example, during a later processing job, AABBC may not occur during ATOs and spoofed transactions, such as if fraudsters have changed their behaviors with ATOs to avoid detection. Thus, AABBC may be removed from identification as a risky behavior pattern if AABBC does not sufficiently occur during a later processing job and/or after a period of time (e.g., over a number or time period for multiple processing jobs).

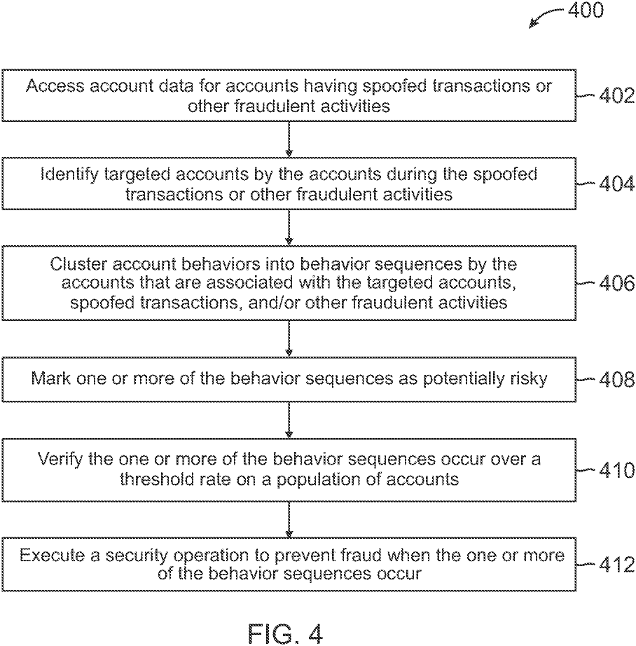

FIG. 4 is a flowchart 400 for real-time account takeover detection using behavior sequence clustering, according to an embodiment. Note that one or more steps, processes, and methods described herein of flowchart 400 may be omitted, performed in a different sequence, or combined as desired or appropriate.

At step 402 of flowchart 400, account data for accounts having spoofed transactions or other fraudulent data is accessed. The account data may correspond to account logs, history, monitored behavior or activities, and/or other data about computing operations engaged in by computing devices using the accounts. For example, the account data may include those operations and activities performed by computing devices when using the account with a computing service, platform, or application provided by a service provider including login, changing account data, interacting with other online entities and/or accounts, and the like. The accounts for which the account data is accessed may include those having an ATO dispute or other flag for spoofed transactions, fraudulent activity, and the like.

At step 404, targeted accounts by the accounts during the spoofed transaction or other fraudulent activities are identified. The targeted accounts may correspond to those that were the other party to a spoofed or fraudulent transaction, or otherwise engaged in an ATO activity with the compromised accounts having the ATO disputes. With the compromised and targeted accounts, account behaviors are accessed. Account behaviors may correspond to those computing operations and activities executed by computing devices with or using computing services, platforms, and applications of an online service provider providing accounts and account services. In this regard, account behaviors may include login, add phone, an account recovery, and the like. More generally, account behaviors may include operations and activities associated with login (as well as from a website or mobile application flow, authentication, add/delete contacts or contact identifiers, account recovery, add/delete/change transaction participant, request transfer/payment/transaction processing, debit or withdraw funds, and may further include measurements of user actions, security verification by computing devices with a server system, a time of the security verification, navigations and requested data loading events, and/or a transaction processing sequence. Each account behavior may be associated with a correspond checkpoint when the account behavior occurs, such as when the login is completed or access to the account is given, when a phone number or other identifier is added to an account or transaction request, and the like. These checkpoints may be used to encode as an identifier so that sequences may be identified based on the particular account behavior that may be performed by multiple computing devices and/or accounts.

At step 406, account behaviors are clustered into behavior sequences by the accounts that are associated with the targeted accounts, the spoofed transactions, and/or the other fraudulent activities. Clustering may be performed by determining those account behaviors occurring in a time period prior to, and/or after when desired, the ATO dispute, activity, and/or spoofed transaction. This may further be limited to those account behaviors linked to the activity with the targeted account and/or that account directly, however, other behaviors may also be clustered include all logins and the like during the time period. For example, using the aforementioned account behaviors, such as login, add phone, an account recovery, and the like, different sequences or patterns may be extracted. In one embodiment, a sequence may include a login, followed by an add phone number, followed by another login to use the account with the newly added fraudulent phone number. Other sequences may include an account recovery followed by a login and then an add phone number, as well as a login via a specific channel and an add phone number for a spoofed transaction.

At step 408, one or more of the behavior sequences are then marked as potentially risky. Marking the behavior sequence as potentially risky may be in response to determining that the behavior sequence includes a sufficient amount or number of individual account behaviors (e.g., over a threshold number or amount) to designate that behavior sequence as meaningful and/or suspicious. For example, individual behaviors or very short behavior sequences (e.g., two or three behaviors) may not be particularly noteworthy as those sequences may often occur even with valid accounts. However, sufficiently lengthy behavior sequences (e.g., over four or five) may be identified as potentially risky.

At step 410, the one or more behavior sequences are verified as occurring over a threshold rate or percentage on a population of accounts. The verification of the one or more behavior sequences may include clustering or otherwise identifying accounts having an occurrence of the behavior sequence and determining this cluster of accounts exceeds the threshold rate, percentage, or number on the population of accounts. That population may be the compromised accounts and/or a general overall set of accounts (e.g., including those that are not compromised) of the service provider. Verification may also allow for the other identified accounts to have interceding behaviors so long as the potentially risky sequence of account behaviors is identified over the selected time period. For example, with a potentially risky sequence of “ABBC” having account behaviors “A”, “B”, and “C”, another account may be clustered or matched that includes “AABBC” or “ACBBC” over the time period as removing the second A in the first or the first C in the second behavior sequences still results in identifying ABBC occurring by each account during the time period. However, more stringent matching rules may also be required whereby interceding account behaviors may cause behavior sequences to not match and cluster those accounts.

At step 412, a security operation to prevent fraud when the one or more of the behavior sequences occur is executed. The security operation may be executed to prevent and/or minimize abuse, fraud, and/or loss caused by an ATO and/or attempt to stop the ATO and provide the account back to the valid user. For example, the security operation may, on detection of a verified risky sequence, prevent use of the account and/or engagement in one or more activities including electronic transaction processing. The security operation may also issue manual challenges and/or multifactor authentication. In order to determine more information regarding the fraudster performing the ATO, the security operation may also log information (e.g., IP address, machine identifier or fingerprint, previous account behaviors, etc.) for the computing device using the account and provide the information to a security team. When matching, similar to step 410, interceding account behaviors may be excluded and removed if the behavior sequence is matched or may cause the risky behavior sequence to not match depending on the settings and parameters of the ATO detection system and operations.

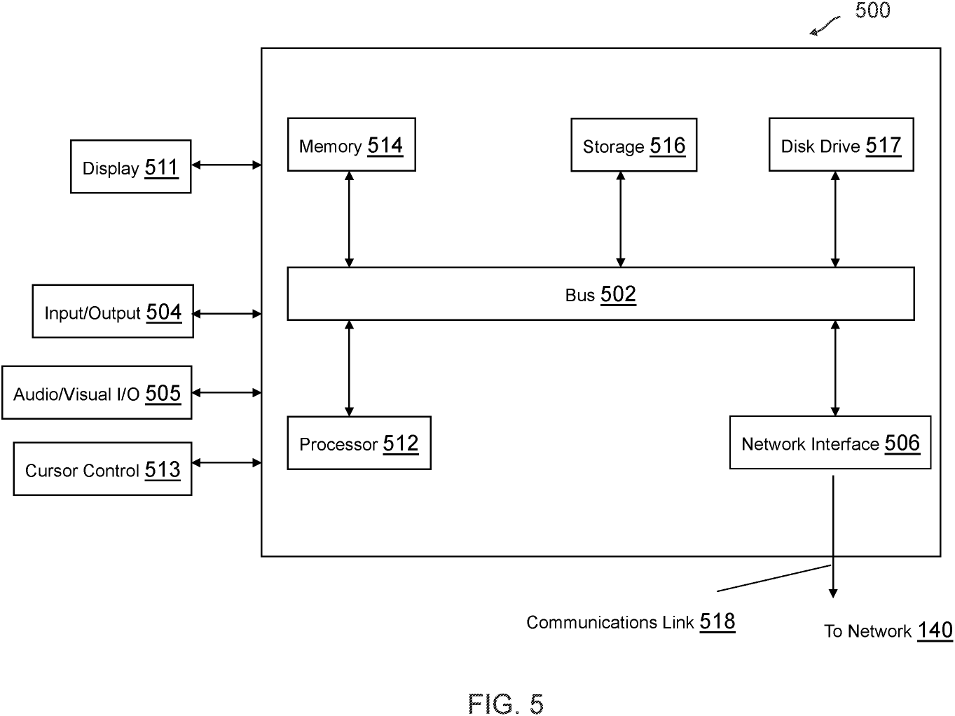

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, images, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output (I/O) component 505 may also be included to allow a user to use voice for inputting information by converting audio signals and/or input or record images/videos by capturing visual data of scenes having objects. Audio/visual I/O component 505 may allow the user to hear audio and view images/video including projections of such images/video. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to execute instructions from the non-transitory memory to cause the system to perform operations comprising:
accessing account data for accounts having fraudulent transaction processing alerts previously flagged for the accounts;
determining, using the account data, targeted accounts that are targeted by the accounts when the fraudulent transaction processing alerts occur;
clustering, using the account data for the accounts, account behaviors by the accounts into one or more behavior sequences, wherein the account behaviors comprise computing operations executed by one or more respective user interface commands on computing devices when utilizing the accounts, and wherein the computing operations are performed by the computing devices with the targeted accounts for the fraudulent transaction processing alerts;
marking a first behavior sequence of the one or more behavior sequences by a first account as a risky behavior sequence based on the fraudulent transaction processing alerts for the accounts; and
clustering at least a portion of the accounts having the fraudulent transaction processing alerts based on the first behavior sequence being executed by the computing devices associated with the at least the portion of the accounts, wherein the clustering results in a first account cluster comprising the portion of the accounts having the fraudulent transaction alerts.

2. The system of claim 1, wherein the operations further comprise:
determining a security operation that prevents additional fraudulent transaction processing on a detection of the first behavior sequence;
monitoring at least one of the accounts or additional accounts for a service provider associated with the system;
detecting the first behavior sequence with a second account based on the monitoring; and
executing the security operation that prevents the additional fraudulent transaction processing by the second account based on the detecting.

3. The system of claim 2, wherein the security operation comprises at least one of a first process that blocks the additional fraudulent transaction processing by the second account or a second process to alert one of a user associated with the second account or a security entity associated with the service provider of the detecting the first behavior sequence.

4. The system of claim 2, wherein the operations further comprise:
issuing, to a device associated with the second account, a manual challenge to confirm a validity of at least one of a use of the second account during the first behavior sequence or an execution the first behavior sequence by the second account.

5. The system of claim 1, wherein the clustering the at least the portion of the accounts comprises verifying that the at least the portion of the accounts associated with first behavior sequence is at or over a threshold percentage of the accounts.

6. The system of claim 1, wherein the fraudulent transaction processing alerts correspond to spoofed transactions performed by the accounts with the targeted accounts, and wherein each of the one or more behavior sequences are performed over a limited time period associated with the spoofed transactions or during a login session that causes the spoofed transactions.

7. The system of claim 1, wherein the operations further comprise:
preventing the portion of the accounts in the first account cluster from executing additional computing operations responsive to at least one of marking the first behavior sequence as risky or detecting the first behavior sequence performed by the first account cluster.

8. The system of claim 1, wherein the first behavior sequence is marked based on the account behaviors for the first behavior sequence meeting or exceeding a threshold account behavior length, wherein the one or more behavior sequences comprise a second behavior sequence that is not marked as the risky behavior sequence based on the account behaviors for the second behavior sequence being below the threshold account behavior length.

9. The system of claim 1, wherein the first behavior sequence is unmarked as the risky behavior sequence in response to marking a second behavior sequence as the risky behavior sequence or accessing new account data for the accounts.

10. The system of claim 1, wherein the clustering the account behaviors into the one or more behavior sequences comprises determining a plurality of behavioral sequences each comprises at least one of the account behaviors.

11. The system of claim 1, wherein the computing operations for the account behaviors comprise at least one of a login action, an authentication action, an add contact identifier action, an account recovery action, or an add transaction participant action.

12. A method comprising:
accessing digital account data for a plurality of accounts that have an account alert that indicates a fraudulent activity engaged in by each of the plurality of accounts, wherein the digital account data comprise a plurality of account behaviors executed by computing devices using the plurality of accounts with a plurality of targeted accounts for the fraudulent activity;
identifying the plurality of account behaviors by the plurality of accounts with the plurality of targeted accounts based on the digital account data;
clustering a plurality of behavior sequences by the plurality of accounts with the plurality of targeted accounts using the digital account data, wherein each of the plurality of behavior sequences comprise one or more of the plurality of account behaviors;
selecting a first behavior sequence of the plurality of behavior sequences as a potential risk sequence for the fraudulent activity;
clustering, using the digital account data, the plurality of accounts based on the first behavior sequence being executed by the computing devices using the plurality of accounts;
verifying, based on the clustering the plurality of accounts, that the first behavior sequence meets or exceeds a threshold occurrence rate by the plurality of accounts for the fraudulent activity performed with the plurality of targeted accounts; and
preventing, with at least one additional account, the fraudulent activity when the first behavior sequence is detected as being performed by the at least one additional account.

13. The method of claim 12, wherein the account alert is a result of a spoofed transaction performed by each of the plurality of accounts with one of the plurality of targeted accounts.

14. The method of claim 12, wherein the preventing comprises blocking additional transaction processing by the at least one additional account when the first behavior sequence is detected.

15. The method of claim 12, wherein the plurality of account behaviors comprise at least one of a measurement of a user action, an authorized security verification by the computing devices with a server system, a time of the authorized security verification, a login from website, a login from a mobile application flow, a transaction processing action, or a transaction processing sequence between at least two of the computing device.

16. The method of claim 12, wherein the verifying comprises determining that at least a portion of the plurality of accounts associated with the first behavior sequence is at or over a threshold percentage of the plurality of accounts.

17. A non-transitory machine-readable medium having stored thereon machine-readable instructions executable to cause a machine to perform operations comprising:
determining a plurality of account behavior sequences for spoofed transactions by accounts of a service provider with targeted accounts, wherein each of the spoofed transactions comprises a fraudulent transaction processing alert, and wherein each of the plurality of account behavior sequences comprises a series of account behaviors executed by computing devices when using the accounts;
determining a first account behavior sequence is a first risky sequence for performing an additional spoofed transaction when detected by the service provider;
clustering accounts having the first account behavior sequence executed by a corresponding one of the computing devices;
verifying that the first account behavior sequence occurs at or over a threshold amount based on the clustering;
monitoring the accounts of the service provider for the first account behavior sequence; and
declining the additional spoofed transaction when the first account behavior sequence is detected based on the monitoring.

18. The non-transitory machine-readable medium of claim 17, wherein prior to the determining the plurality of account behavior sequences, the operations further comprise:
determining the accounts having the spoofed transactions.

19. The non-transitory machine-readable medium of claim 18, wherein the operations further comprise:
identifying the targeted accounts by the accounts for the spoofed transaction based on the determining the accounts having the spoofed transactions.

20. The non-transitory machine-readable medium of claim 17, wherein the account behaviors comprise at least one of a login, a user authentication, a transaction processing activity, a user input to the computing device, or a navigation request on a website or in a mobile application.
